(19) United States
(12) Patent Application Publication
(10) Pub. No.: US 2026/0338200 A1
(43) Pub. Date: Oct. 29, 2026

(54) DEVICE FOR CONTROLLING A HYDRAULIC MACHINE

(71) Applicant: Voith Patent GmbH, Heidenheim (DE)

(72) Inventors: Rouven Hohage, Buxheim (DE); Thomas Zeller, Aalen (DE)

(73) Assignee: Voith Patent GmbH, Heidenheim (DE)

(21) Appl. No.: 19/705,453

(22) Filed: Jun. 11, 2026

Related U.S. Application Data
(63) Continuation of application No. PCT/EP2024/074937, filed on Sep. 6, 2024.

(30) Foreign Application Priority Data
Dec. 11, 2023 (DE) 10 2023 134 582.6
Sep. 6, 2024 (WO) PCT/EP2024/074937

(51) Int. Cl. F04D 29/48; F15B 1/027

(52) U.S. Cl. CPC F04D 29/486; F15B 1/0275; F05B 2240/12; F15B 2211/20576

(57) ABSTRACT

A device for controlling a hydraulic machine with a wicket gate includes a first pump assembly including a pump which is designed as a 4Q piston pump and is connected to a pump drive in such a way that the pump drive can drive the pump, the device including a second pump assembly which is connected with a suction side to a collecting and expansion tank and is connected with a pressure side via an accumulator charging line with the accumulator, the device including a check valve which is arranged in the accumulator charging line in such a way that it can prevent a flow from the accumulator to the second pump assembly.

### CROSS REFERENCE TO RELATED APPLICATIONS

This is a continuation of PCT application no. PCT/EP2024/074937, entitled “APPARATUS FOR CONTROLLING A HYDRAULIC MACHINE”, filed Sep. 6, 2024, which is incorporated herein by reference. PCT application no. PCT/EP2024/074937 claims priority to German patent application no. 10 2023 134 582.6, filed Dec. 11, 2023, which is incorporated herein by reference.

### BACKGROUND OF THE INVENTION

### 1. Field of the Invention

The present invention relates to hydraulic machines.

### 2. Description of the Related Art

A generic device is disclosed in DE 10 2017 106 693 B3. The device disclosed therein is characterized by high energy efficiency, good environmental compatibility, ease of maintenance, and low acquisition and operating costs. The disclosed device is moreover suitable for controlling many diverse types of hydraulic machines. For example, both the guide vanes and the impeller blades of hydraulic machines can be controlled. In addition, double rod cylinders or differential cylinders can be actuated. The disclosed device is particularly efficient when control is achieved via a so-called deadband, since then no control movements are required for extended periods.

With the decentralization of energy generation towards renewable energy sources such as wind and solar power plants, hydroelectric power plants will have to make a greater contribution to frequency control (also called primary control) of the grids in the future. In most cases today, the respective grid codes of the federal states still permit a certain dead band in frequency control (a range in which no response to setpoint changes occurs), so that the wicket gate does not need to be activated within the frequency dead band, and thus the dual pump of the device known from DE 10 2017 106 693 B3 is also inactive within the frequency dead band.

Due to the increasingly large grid fluctuations from renewable energy producers, this deadband will have to be set to zero more and more frequently, also for hydroelectric power plants. This direct integration into frequency control means continuous control of the wicket gate with very slow adjustment movements. In the device known from DE 10 2017 106 693 B3, this results in continuous control operation of the drive and the associated double pump at low speeds, thus increasing the risk of increased pump wear.

What is needed in the art is to optimize the device known from the state of the art for use in controlling the wicket gate of a hydraulic machine in a hydroelectric power plant, wherein the device should be suitable for continuous control operation without deadband.

### SUMMARY OF THE INVENTION

The present invention relates to a device for controlling a hydraulic machine in a hydroelectric power plant, including a wicket gate, in particular a device for controlling a turbine or pump turbine with a Francis type impeller. The present invention provides a device for controlling a hydraulic machine in a hydroelectric power plant with a wicket gate and a device for implementing an emergency shutdown, characterized by low energy consumption and high efficiency while ensuring all operational and safety-related requirements of a hydraulic machine and suitable for continuous control operation without deadband.

The following numbered sentences form part of the Summary of the Invention and thus represent elements of the present invention:
1. A device for controlling a hydraulic machine with a wicket gate, including a first pump assembly (2), a variable-speed pump drive (3), an accumulator (5), at least one hydraulic cylinder (6) which operates as a double-rod cylinder and actuates the wicket gate, an emergency shut-off valve (71), two pilot-operated check valves (81, 82) and two pilot valves (91, 92) for unlocking check valves (81, 82), and wherein the device also includes a collecting and expansion tank (1), an emergency shut-off solenoid valve (72) and at least one throttle (10), and wherein a first port of first pump assembly (2) is connected to the opening side and a second port of first pump assembly (2) is connected to the closing side of hydraulic cylinder (6), and wherein collecting and expansion tank (1) is connected with the opening side, and accumulator (5) is connected with the closing side of hydraulic cylinder (6), and wherein emergency shut-off valve (71) is located in the line between hydraulic cylinder (6) and collecting and expansion tank (1), and a pilot-operated check valve (81, 82) is respectively located in one of the lines from first pump assembly (2) to hydraulic cylinder (6) and is oriented such that hydraulic fluid can pass through to hydraulic cylinder (6) in every state of check valves (81, 82), and the device further includes lines which connect accumulator (5) to each of the two pilot-operated check valves (81, 82) and emergency shut-off valve (71) in order to be able to unlock pilot-operated check valves (81, 82) and to close emergency shut-off valve (71), wherein these lines form a single line over at least one section, where emergency shut-off solenoid valve (72) is arranged such that it is open during operation of the hydraulic machine, and wherein the pilot valves (91, 92) are each located in the separate sections of the lines between accumulator (5) and pilot-operated check vales (81, 82) and are designed to be electrically controllable, and wherein the at least one throttle (10) is located in the line to the opening side of hydraulic cylinder (6) in order to be supplied with hydraulic fluid during each movement of hydraulic cylinder (6), characterized in that first pump assembly (2) includes a pump which is designed as a 4Q piston pump and is connected to pump drive (3) in such a way that the latter can drive the pump, and wherein the device includes a second pump assembly (8) which is connected with a suction side to collecting and compensation tank (1), and is connected with a pressure side via an accumulator charging line with accumulator (5), and wherein the device includes a check valve (86) which is arranged in the accumulator charging line in such a way that it can prevent a flow from accumulator (5) to second pump assembly (8).
2. The device according to sentence 1, wherein the device includes at least one additional throttle (11, 12) which is located either in the line between collecting and compensating tank (1) and the port into the line from first pump assembly (2) to the opening side of hydraulic cylinder (6) or in the line between accumulator (5) and the port into the line from first pump assembly (2) to the closing side of hydraulic cylinder (6).
3. The device according to sentence 1, wherein the device includes at least two additional throttles (11, 12), so that at least one throttle (11, 12) is located in each of the lines referred to in sentence 2.
4. The device in accordance with one of the preceding sentences, wherein the 4Q piston pump has a flushing oil connection, and wherein the device includes a changeover valve (85) and a flushing throttle (88), and wherein between second pump assembly (8) and check valve (86) a flushing line branches off from the accumulator charging line which is connected with the flushing connection, and wherein changeover valve (85) and flushing throttle (88) are arranged in the flushing line.
5. The device according to one of the preceding sentences, wherein the device includes two pressure relief valves (30, 31), one of which is always connected to one of the lines between pilot-operated check valves (81, 81) and hydraulic cylinder (6).
6. The device according to one of the preceding sentences, wherein the device includes an electrically controllable solenoid valve (20) which is arranged in the same line as emergency shut-off solenoid valve (72) and is designed to decouple pilot valves (91, 92) from accumulator (5).
7. The device according to one of the preceding sentences, wherein the device includes a port (50) for additional emergency shut-off valves that are arranged in the same line as emergency solenoid shut-off valve (72).
8. The device according to one of the preceding sentences, wherein the device includes a port (40) for additional users of hydraulic fluid, which are arranged in the line from accumulator (5) to hydraulic cylinder (6).
9. The device according to one of the preceding sentences, wherein from the flushing line between changeover valve (85) and flushing throttle (88) a return line branches off, which is connected to collecting and expansion tank (1), and wherein a pre-tensioned check valve (87) is arranged in the return line such that, after overcoming a predefined force, hydraulic fluid can enter collecting and expansion tank (1) through the return line.
10. The device according to one of the preceding sentences, wherein a filter (83) is located in the flushing line.
11. The device according to one of the preceding sentences, wherein a heat exchanger (84) is located in the flushing line.
12. The device according to one of the preceding sentence, wherein emergency shut-off solenoid valve (72) is designed so that it is permanently energized during operation of the hydraulic machine and is continuously open in this position.
13. The device according to one of the preceding sentence in conjunction with sentence 6, wherein emergency shut-off solenoid valve (72) is designed so that, upon electrical excitation, it can open emergency shut-off valve (71) and decouple pilot valves (91, 92) from accumulator (5).

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a device according to the invention;

FIG. 2 is an arrangement of two differential cylinders, which together operate as a double-rod cylinder.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

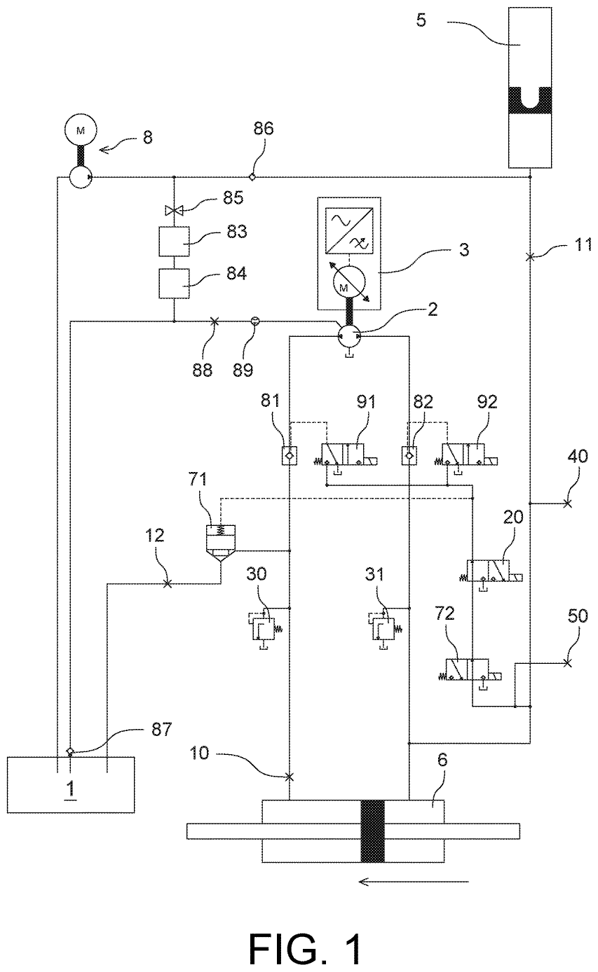

FIG. 1 is a schematic representation of the structure of a device according to the present invention for controlling a hydraulic machine. The device includes a collecting and expansion tank, designated 1, a pump assembly, designated 2, a variable-speed pump drive, designated 3, an accumulator, designated 5, a hydraulic cylinder, designated 6, an emergency shut-off valve, designated 71, an emergency shut-off solenoid valve, designated 72, two pilot-operated check valves, designated 81 and 82, two pilot valves, designated 91 and 92, three throttles, designated 10, 11 and 12, an optional solenoid valve, designated 20, two optional pressure relief valves, designated 30 and 31, and two optional ports, designated 40 and 50. The arrow below hydraulic cylinder 6 indicates its closing direction.

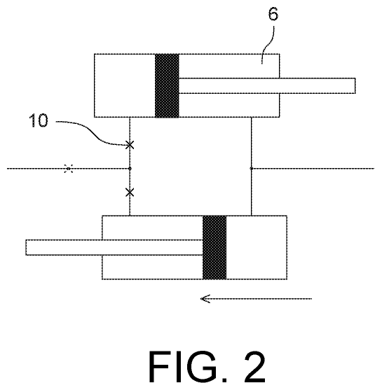

Hydraulic cylinder 6 is a hydraulic cylinder that actuates the guide vanes of a hydraulic machine. For this purpose, hydraulic cylinder 6 typically engages the guide wheel ring. Hydraulic cylinder 6 shown in FIG. 1 is designed as a double rod cylinder. More than one hydraulic cylinder can also be provided to actuate the guide vanes. FIG. 2 shows an example of an arrangement of two hydraulic cylinders, wherein each hydraulic cylinder is designed as a differential cylinder, which are however connected in such a way that, together, they act as a double rod cylinder.

Pump assembly 2 includes exactly one pump with reversible delivery direction. Pump of pump assembly 2 is designed as a 4Q piston pump, possibly as a flushed 4Q piston pump (see below). In each case, one connection of the pump is connected to a control line of the hydraulic cylinder, so that in one rotational direction of the shaft, the pump pumps hydraulic fluid into a first chamber of hydraulic cylinder 6 and at the same time takes in hydraulic fluid from the other chamber of hydraulic cylinder 6. In the opposite rotational direction of the shaft, the action is reversed. In FIG. 1, the right port of the pump (via pilot-controlled check valve 82) is connected to the closing side of hydraulic cylinder 6 and the left port of the pump (via pilot-operated check valve 81) is connected to the opening side of hydraulic cylinder 6.

The shaft of pump assembly 2 is driven by variable-speed pump drive 3, which can be operated in both directions of rotation. Pump drive 3 typically includes an electric servo motor, which is electrically powered by a frequency converter. Due to its design, the 4Q piston pump can generate maximum pressure indefinitely at very low speeds without exhibiting an increased risk of wear, as is necessary for the continuous control of the wicket gate of the hydraulic machine, which participates in the frequency control of the transmission network.

In this operating mode, that is, when the 4Q piston pump is in continuous operation, the 4Q piston pump may need to be cooled. Whether such a pump requires cooling depends on the technical specifications of the specific hydroelectric plant. If a pump with cooling has to be used, then such a 4Q piston pump has a designated so-called flushing oil connection. By way of this connection, the hydraulic oil of the collecting tank 1 can be used to flush the 4Q piston pump and thus to transport heat during continuous operation. To generate the volume flow required for this, a device according to the present invention includes an additional pump assembly, which is designated 8 in FIG. 1. In order to distinguish between pump assembly 2 and 8, pump assembly 2 is referred to as the “first pump assembly” and pump assembly 8 as the “second pump assembly”.

In addition to flushing the 4Q piston pump, second pump assembly 8 also serves to charge accumulator 5. Second pump assembly 8 is connected at its suction side to collecting and expansion tank 1 and at its discharge side to accumulator 5. The line from the pressure side to accumulator 5 is referred to below as the “accumulator charging line.” A check valve 86 is arranged in the accumulator charging line. The check valve is positioned to prevent flow from the accumulator to the second pump assembly. Between second pump assembly 8 and check valve 86, a line branches off from the accumulator charging line, which is hereinafter referred to as the “flushing line” and which is connected to the flushing connection of first pump assembly 2. A changeover valve 85 is located in the flushing line. A throttle 88, and an optional flow sensor 89 are also arranged in the flushing line. Throttle 88 is referred to below as the “flushing throttle” to better distinguish it from the other throttles and is optionally adjustable.

An additional line can optionally branch off from the flushing line between changeover valve 85 and flushing throttle 88, which hereinafter is referred to as the “return line” and which is connected to collecting and expansion tank 1. In the optional return line, a pre-tensioned check valve 87 is arranged. The pre-tensioned check valve is arranged in such a way that, after overcoming a predefined force, hydraulic fluid can pass through the return line into collecting and expansion tank 1. If changeover valve 85 is open, then second pump assembly 8 can supply first pump assembly 2 with flushing oil in non-pressurized circulation. The flushing oil volume flow is defined by flushing throttle 88. Optionally, the flushing oil volume flow can be regulated as needed by an adjustable throttle 88 and optional flow sensor 89.

The optional return line allows a portion of the flow rate to return to collecting and expansion tank 1 via spring-loaded check valve 87. This allows the elements used for flushing first pump assembly 2 and charging accumulator 5 to be designed more flexibly. For example, second pump 8 can be designed to be larger than necessary for flushing alone, allowing accumulator 5 to be charged more quickly.

To charge accumulator 5, changeover valve 85 is closed. The two operating modes are described in more detail below. The position of changeover valve 85 is electrically controlled.

Optionally, a filter, which is identified with 83 in FIG. 1, and a heat exchanger, which is identified 84, can be arranged in the flushing line. Filter 83 serves to clean hydraulic fluid, and heat exchanger 84 can be used to cool or heat the hydraulic fluid. Elements 83 and 84 are arranged between changeover valve 85 and flushing throttle 88.

Pilot-operated check valves 81 and 82, which are arranged in the connecting lines of hydraulic cylinder 6 with first pump assembly 2 such that they prevent movement of the hydraulic cylinder piston when unlocked, are each connected to one of the pilot valves 91, 92. Each of these are connected (via valves 20 and 72) with accumulator 5. Opening a pilot valve 91, 92 causes the corresponding check valve 81, 82 to be unlocked. Opening of pilot valves 91, 92 is caused by the (electric) regulator of the hydraulic machine by energizing them. Each pilot valve 91, 92 can be energized separately.

An accumulator 5 is connected to the closing side of hydraulic cylinder 6. Emergency shut-off valve 71 is connected to the opening side of hydraulic cylinder 6 and collecting and expansion tank 1 in such a way that a flow between the opening side of hydraulic cylinder 6 and collecting and expansion tank 1 is only possible if emergency shut-off valve 71 is open. The status of emergency shut-off valve 71 is controlled via emergency shut-off solenoid valve 72, which is located in a hydraulic line between emergency shut-off valve 71 and accumulator 5. Emergency shut-off solenoid valve 72 is also located in the lines between pilot valves 91, 92 and accumulator 5. In an optional embodiment, spring-loaded emergency shut-off solenoid valve 72 is always permanently energized during operation, wherein emergency shut-off valve 71 is closed and pilot valves 91, 92 are supplied with oil pressure by accumulator 5 (that is, check valves 81, 82 can be unlocked by pilot valves 91, 92 in this state).

Throttle 10, which is also referred to as “basic throttle”, is located in the line between the opening side of hydraulic cylinder 8 and check valve 81, but before the junction in this line to emergency shut-off valve 71, that is, in the immediate vicinity of hydraulic cylinder 6. Throttle 11 is located in the line that connects accumulator 5 to the rest of the device. Throttle 12 is located in the line between emergency shut-off valve 71 and collecting and expansion tank 1. Both throttles 11 or 12 are to be considered optional (see the explanations regarding the emergency shut-off function).

Optionally, the device can include additional emergency shut-off control valves (for example, an overspeed valve, etc.). These can be connected via port 50, which is located in the same hydraulic line as emergency shut-off solenoid valve 72.

Additional consumers can optionally be connected to accumulator 5 via port 40. Port 40 is located in the hydraulic line that connects accumulator 5 to the rest of the device.

The inventive device illustrated in FIG. 1 includes a single hydraulic cylinder 6, designed as a double-rod cylinder. As already mentioned, a device according to the present invention may also include more than oneoadl hydraulic cylinder 6. Thus, the device according to the present invention can include any number of hydraulic cylinders, which are designed as double-rod cylinders. In this case, the hydraulic cylinders are connected hydraulically in parallel. The parallel connection then replaces the single hydraulic cylinder 6 shown in FIG. 1. A common basic throttle 10 and/or a separate basic throttle 10 can be provided for each hydraulic cylinder. Hydraulic cylinders are also known in which a rod is arranged on only one side, but which nevertheless acts as a double-rod cylinder, i.e., has equally sized effective surfaces on both hydraulic sides. This type of hydraulic cylinder is usually referred to as a synchronous cylinder. In a device according to the present invention, any number of synchronous cylinders can be used, which are arranged as described for the double-rod cylinders. In a device according to the present invention, an even number of differential cylinders can also be used. Thereby, two differential cylinders are hydraulically connected, reversed in parallel, so that together they act like a double-rod cylinder. FIG. 2 shows such an arrangement of two differential cylinders. If more than two differential cylinders are used, the cylinder pairs are again hydraulically connected in parallel. In this document, all described hydraulic cylinder configurations are understood to mean “at least one hydraulic cylinder that acts as a double-rod cylinder.”

The following describes in more detail the functional principles of the device according to the present invention, in the individual operating states of the hydraulic machine, and explains the advantages of the device. Here, the initial state is assumed to be that accumulator 5, which is directly connected with the closing side of hydraulic cylinder 6, is charged with a defined pressure and that hydraulic cylinder 6 is in a random intermediate position.

Control operation of the hydraulic machine:
A distinction is made herein between conventional control operation with active dead band and regular operation for frequency control with inactive dead band.

### Conventional Control Operation:

As long as the position of hydraulic cylinder 6 is to be maintained, pilot solenoid valves 91, 92, controlled by the regulator of the hydraulic machine are in the de-energized state. As a result, pilot-operated check valves 81, 82 in the control lines to the opening and closing side of hydraulic cylinder 6 are also closed, and cylinder 6 is held in position without leakage. In this state, the variable-speed drive 3 is switched off so that no energy loss (heat) is introduced into the system. If the device is used exclusively in conventional control operation, cooling of the hydraulic fluid can be omitted, resulting in the advantage of clearly improved energy efficiency.

In this state (holding the position), second pump assembly 8 can also be deactivated.

If a control process becomes necessary (i.e., a change in the setpoint or the control deviation exceeds a certain value (deadband)), pilot valves 91 and 92 are energized via the controller, which leads to the opening of the pilot-operated check valves. Now the hydraulic cylinder can be positioned directly above variable-speed pump drive 3.

The oil volume, and thus the pressure, in accumulator 5 remains almost constant, so that energy is available for an emergency shutdown over an extended period, and accumulator 5 does not need to be charged frequently. Accumulator 5 empties slowly when check valve 82 on the accumulator side is opened. Draining is caused by internal pump leakage of the piston pump. Additionally, the pilot oil required for pilot valves 91 and 92 is drawn from accumulator 5; but this represents only a very small amount.

After reaching the desired position, pilot valves 91, 92 are deenergized, whereby cylinder 6 can be held in its position again without the application of energy.

Since such a control process takes place very quickly in a conventional control operation and sufficient time elapses between the individual control processes, flushing of the 4Q piston pump during such a control process can usually be omitted.

### Control Operation for Frequency Control:

This operating mode is characterized by a continuous control process as described above. The 4Q piston pump of first pump assembly 2 must be continuously flushed by second pump assembly 8.

### Emergency Shutdown:

To ensure the safe shutdown of the hydraulic machine in the event of a fault, an emergency shutdown function is optionally implemented, allowing the system to be shut down without power supply (or in the event of a defect in the variable-speed drive 3). In the event of an emergency shutdown, emergency shutdown solenoid valve 72, which is continuously energized during operation, is de-energized, whereupon emergency shutdown valve 71 opens. This transforms the closed hydraulic control circuit into an open circuit. Accumulator 5 is connected to the closing side of hydraulic cylinder 6, with the opening side now diverting to collecting and expansion tank 1. Simultaneously, pressure to pilot valves 91 and 92 is also relieved, causing pilot-operated check valves 81 and 82 to close. This reliably prevents, for example, the accumulator volume from being unintentionally drained due to a defect or leak in first pump assembly 2, thus rendering it unavailable for closure.

In this open circuit, accumulator 5 delivers a defined volume within defined pressure limits. Therefore, a defined closing time can be reliably set with the help of basic throttle 10. Safety can be further increased with an optional additional throttle 11 or 12 connected in series. If two additional throttles 11 and 12 are actually connected in series, this results in greater flexibility and greater robustness against, for example, a line break in the line between basic throttle 10 and quick shutdown valve 71, since the additional throttling effect is distributed across two throttles, of which only one (12) fails due to the line break.

Basic throttle 10 creates a back pressure during the movement of hydraulic cylinder 6, against which first pump assembly 2 acts and which must therefore be kept within certain limits (nominal pressures of the lines and components to be maintained, power of pump drive 3, etc.). Therefore, individual design of individual throttles 10, 11, 12 is necessary. The key point here is that main throttle 10 must always account for the largest possible share of the total throttling effect and, consequently, of the closing time. One of the reasons for this is that the location of basic throttle 10 directly in the opening side of the at least one hydraulic cylinder 6 ensures a limitation of the closing time even in the event of a line break on the opening control side (that is, the line between basic throttle 10 and pump assembly 2).

In order to protect the device against an impermissibly high pressure, pressure relief valves 30, 31 can optionally be installed on the opening and closing sides with regard to at least one hydraulic cylinder 6. It is clear that pressure relief valve 31 can also be integrated in accumulator 5.

### Accumulator Charging Function:

The accumulator charging function serves to replenish the hydraulic fluid removed from accumulator 5 by the internal pump leakage of first pump assembly 2 and to maintain the accumulator pressure for the emergency shut-off function.

Accumulator 5 is monitored for its fill level and system pressure by way of corresponding level and pressure sensors. During operation, the hydraulic fluid volume and pressure in accumulator 5 are maintained within a defined pressure hysteresis, regardless of the position of hydraulic cylinder 6.

If the apparatus of the present invention is used for frequency control, second pump assembly 8 is used most of the time for flushing first pump assembly 2 if cooling of it is necessary. During this, changeover valve 85 is open. If the accumulation pressure drops too far, changeover valve 85 is closed, thus interrupting the flushing process. Instead, second pump assembly 8 pumps hydraulic fluid into accumulator 5 until the target pressure is reached. If second pump assembly 8 is deactivated (for example, during conventional control operation), then it is activated for accumulator charging.

Flushing of 4Q piston pump can be omitted during the short accumulator charging process without risking overheating. Once the charging process is complete, the previous active function of second pump assembly 8 resumes.

The accumulator charging function is active during normal operation and when the hydraulic machine is stationary. This always ensures appropriate safety for a possible emergency shut-down, as well as being available as quickly as possible during start of the hydraulic machine.

### Optional Quick-Closing Function:

Normally, first pump assembly 2 is designed with regard to the size, speed and power of the pump so that the opening and closing times of hydraulic cylinder 6 required for the specific application can be achieved solely via pump drive 3.

For example, if large hydraulic cylinder volumes are present and, in contrast to the closing times, the opening times may be significantly longer, in order to keep the dimensions of first pump assembly 2 and pump drive 3 as small as possible (space constraints, spare part costs, etc.), they could be designed so that hydraulic cylinder 6 can only be moved with the minimum opening time.

To achieve a faster closing time (for example, in the case of a hydropower regulator during load shedding), quick-closing solenoid valve 20 is optionally provided, located in the same hydraulic line as emergency shut-down solenoid valve 72. By activating valve 20, the accumulator volume can be used for closing. This energizes quick-closing solenoid valve 20, which in turn opens emergency shut-down valve 71. Simultaneously, the pressure supply to pilot valves 91 and 92 hydraulically isolates the system, so that pilot-operated check valves 81 and 82 in the control lines also close. First pump assembly 2 can then be controlled with maximum flow rate in the closing direction during this process. The support provided by first pump assembly 2 minimizes the volume of oil drawn from accumulator 5. This has the advantage that accumulator 5 is drained to a lesser extent, and the closing time—which is set via main throttle 10 directly on hydraulic cylinder 6—can be adjusted more precisely due to the smaller difference between the initial and final pressures in accumulator 5.

For example, to enable the machine to be resynchronized following a load shedding event in a water turbine, quick-closing valve 20 is de-energized once a defined opening is reached. At the same time, “fine control” is now transferred back to variable-speed pump drive 3, and the machine can be resynchronized. The pressure and oil volume in accumulator 5 is still high enough to allow for a potentially necessary emergency shutdown. Nevertheless, in this situation, accumulator 5 should be refilled as quickly as possible. This can easily be done by second pump assembly 8 as described above.

### Heating Function:

If the oil temperature falls below a defined value, the control system initiates operation of first pump assembly 2 by opening pilot-operated check valves 81 and 82. This results in a slow discharge of accumulator 5, thereby triggering periodic accumulator charging cycles. Heat is generated during the charging process, which can be used to heat the system. Alternatively, the waste heat from second pump assembly 8 in the unpressurized circuit or an optional heat exchanger 84 can be used to heat the system.

### REFERENCE NUMBER LIST

1 collecting and expansion tank
2 first pump assembly
3 variable speed pump drive
5 accumulator
6 hydraulic cylinder
8 second pump assembly
10 throttle—“basic throttle”
11 throttle
12 throttle
20 quick-closing solenoid magnetic valve
30 pressure relief valve
31 pressure relief valve
40 port
50 port
71 emergency shut-off valve
72 emergency shut-off solenoid valve
81 pilot controlled check valve
82 pilot controlled check valve
83 filter
84 heat exchanger
85 changeover valve
86 check valve
87 Spring-loaded check valve
88 throttle—“flushing throttle”
89 flow sensor
91 pilot valve
92 pilot valve

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A device for controlling a hydraulic machine with a wicket gate, the device comprising:
a first pump assembly including a first port and a second port, the first pump assembly further including a pump which is formed as a 4Q piston pump;
a variable-speed pump drive, the pump of the first pump assembly being connected to the variable-speed pump drive such that the variable-speed pump drive is configured for driving the pump;
an accumulator, which includes an accumulator charging line;
at least one hydraulic cylinder, which is configured for operating as a double-rod cylinder and for actuating the wicket gate, the at least one hydraulic cylinder including an opening side and a closing side, the first port of the first pump assembly being connected to the opening side, the second port of the first pump assembly being connected to the closing side, the accumulator being connected with the closing side;
an emergency shut-off valve;
two pilot-operated check valves, including a first pilot-operated check valve and a second pilot-operated check valve;
two pilot valves configured for unlocking the two pilot-operated check valves;
a collecting and expansion tank, the collecting and expansion tank being connected with the opening side of the at least one hydraulic cylinder;
a plurality of lines, the plurality of lines including a line between the at least one hydraulic cylinder and the collecting and expansion tank, the emergency shut-off valve being located in the line between the at least one hydraulic cylinder and the collecting and expansion tank, the plurality of lines including a first line from the first pump assembly to the at least one hydraulic cylinder and a second line from the first pump assembly to the at least one hydraulic cylinder, the first pilot-operated check valve being located in the first line from the first pump assembly to the at least one hydraulic cylinder and being oriented such that a hydraulic fluid passes through to the at least one hydraulic cylinder in every state of the first pilot-operated check valve, the second pilot-operated check valve being located in the second line from the first pump assembly to the at least one hydraulic cylinder and being oriented such that the hydraulic fluid passes through to the at least one hydraulic cylinder in every state of the second pilot-operated check valve, the plurality of lines including a group of lines which connect accumulator to each of the two pilot-operated check valves and the emergency shut-off valve so as to unlock the two pilot-operated check valves and to close the emergency shut-off valve, the plurality of lines including separate sections of lines between the accumulator and the two pilot-operated check valves, the two pilot valves being each located in the separate sections of lines between the accumulator and the two pilot-operated check valves and being configured to be electrically controllable;
an emergency shut-off solenoid valve, the plurality of lines forming a single line over at least one section of the device, the emergency shut-off solenoid valve being arranged in the single line over the at least one section of the device such that the emergency shut-off solenoid valve is open during operation of the hydraulic machine;
at least one throttle, the plurality of lines including a line to the opening side of the at least one hydraulic cylinder, the at least one throttle being located in the line to the opening side of the at least one hydraulic cylinder and thereby being configured for being supplied with the hydraulic fluid during each movement of the at least one hydraulic cylinder;
a second pump assembly, which includes a suction side and a pressure side, the second pump assembly being connected by way of the suction side to the collecting and expansion tank and being connected by way of the pressure side to the accumulator via the accumulator charging line; and
an additional check valve, which is arranged in the accumulator charging line such that the additional check valve is configured for preventing a flow from the accumulator to the second pump assembly.

2. The device according to claim 1, the plurality of lines further including a line from the first pump assembly to the opening side of the at least one hydraulic cylinder and a line from the first pump assembly to the closing side of the at least one hydraulic cylinder, the device further including a port into the line from the first pump assembly to the opening side of the at least one hydraulic cylinder and a port into the line from the first pump assembly to the closing side of the at least one hydraulic cylinder, the plurality of lines further including (i) a line between the collecting and expansion tank and the port into the line from the first pump assembly to the opening side of the at least one hydraulic cylinder and (ii) a line between the accumulator and the port into the line from the first pump assembly to the closing side of the at least one hydraulic cylinder, the device further including at least one additional throttle, which is located either in the line between the collecting and expansion tank and the port into the line from the first pump assembly to the opening side of the at least one hydraulic cylinder or in the line between the accumulator and the port into the line from the first pump assembly to the closing side of the at least one hydraulic cylinder.

3. The device according to claim 1, wherein the device includes at least two of the at least one additional throttle, such that (a) the line between the collecting and expansion tank and the port into the line from the first pump assembly to the opening side of the at least one hydraulic cylinder is provided with at least one of the at least two additional throttles being located therein and (b) the line between the accumulator and the port into the line from the first pump assembly to the closing side of the at least one hydraulic cylinder is provided with at least one of the at least two additional throttles being located therein.

4. The device according to claim 1, wherein the 4Q piston pump includes a flushing oil connection, wherein the device further includes a changeover valve and a flushing throttle, wherein the plurality of lines further includes a flushing line, wherein between the second pump assembly and the additional check valve the flushing line branches off from the accumulator charging line, which is connected with the flushing oil connection, wherein the changeover valve and the flushing throttle are arranged in the flushing line.

5. The device according to claim 1, wherein the device further includes two pressure relief valves, which includes a first pressure relief valve and a second pressure relief valve, wherein the plurality of lines includes a line between a first one of the two pilot-operated check valves and the at least one hydraulic cylinder and a line between a second one of the two pilot-operated check valves and the at least one hydraulic cylinder, wherein at least one of (i) the first pressure relief valve is always connected to the line between the first one of the two pilot-operated check valves and the at least one hydraulic cylinder and (ii) the second pressure relief valve is always connected to the line between the second one of the two pilot-operated check valves and the at least one hydraulic cylinder.

6. The device according to claim 1, wherein the device further includes an electrically controllable solenoid valve, which is arranged in a same line—that is, the single line over the at least one section of the device—as the emergency shut-off solenoid valve and is configured to decouple the two pilot valves from the accumulator.

7. The device according to claim 6, wherein the device includes additional emergency shut-off valves and a port for the additional emergency shut-off valves which is arranged in the same line as emergency solenoid shut-off valve.

8. The device according to claim 1, wherein the plurality of lines includes a line from the accumulator to the at least one hydraulic cylinder, wherein the device includes a port arranged in the line from the accumulator to the at least one hydraulic cylinder, the port being for additional users of the hydraulic fluid.

9. The device according to claim 1, wherein the 4Q piston pump includes a flushing oil connection, wherein the device further includes a changeover valve and a flushing throttle, wherein the plurality of lines further includes a flushing line, wherein between the second pump assembly and the additional check valve the flushing line branches off from the accumulator charging line, which is connected with the flushing oil connection, wherein the changeover valve and the flushing throttle are arranged in the flushing line, wherein the device further includes a return line and a pre-tensioned check valve, wherein from the flushing line between the changeover valve and the flushing throttle the return line branches off, the return line being connected to the collecting and expansion tank, wherein the pre-tensioned check valve is arranged in the return line and is configured such that, after overcoming a predefined force, the hydraulic fluid enters the collecting and expansion tank through the return line.

10. The device according to claim 9, wherein the device further includes a filter located in the flushing line.

11. The device according to claim 9, wherein the device further includes a heat exchanger located in the flushing line.

12. The device according to claim 1, wherein emergency shut-off solenoid valve is configured for being permanently energized during operation of the hydraulic machine and thereby for being continuously open in a position associated therewith.

13. The device according to claim 1, wherein the device further includes an electrically controllable solenoid valve, which is arranged in a same line—that is, the single line over the at least one section of the device—as the emergency shut-off solenoid valve and is configured to decouple the two pilot valves from the accumulator, wherein the emergency shut-off solenoid valve is configured such that, upon electrical excitation thereof, the emergency shut-off solenoid valve opens the emergency shut-off valve and decouples the two pilot valves from the accumulator.
